(19) United States
(12) Patent Application Publication
(10) Pub. No.: US 2012/0054637 A1
(43) Pub. Date: Mar. 1, 2012

(54) METHOD, APPARATUS, COMPUTER PROGRAM AND USER INTERFACE

(75) Inventors: JUHA ARRASVUORI, Tampere (FI); RIKU SUOMELA, Espoo (FI)

(73) Assignee: Nokia Corporation

(21) Appl. No.: 12/870,305

(22) Filed: Aug. 27, 2010

(51) Int. Cl. G06F 15/16; G06F 3/01

(52) U.S. Cl. 715/748

(57) ABSTRACT

A method, apparatus, computer program and user interface wherein the method comprises: displaying an assessment area on a display of a first apparatus; displaying an item indicative of transfer data in the assessment area where the transfer data originates from a second apparatus; and determining whether a user input has been made accepting the transfer data, wherein if a user input accepting the transfer data has been made, enabling use of the transfer data by the first apparatus and if a user input accepting the transfer data has not been made, preventing use of the transfer data by the first apparatus.

### TECHNOLOGICAL FIELD

Embodiments of the present invention relate to a method, apparatus, computer program and user interface. In particular, they relate to a method, apparatus, computer program and user interface for enabling data to be transferred between a source apparatus and a target apparatus.

### BACKGROUND

Apparatus which enable data to be transferred between a source apparatus and a target apparatus are known. For example a user of a hand held electronic device, such as a mobile telephone, may wish to provide content, such as contact details or photographs which are stored in their device, to other users. Alternatively they may wish to transfer the content from a first apparatus to a second apparatus. For instance they may have obtained some content such as a media file or photograph on a first apparatus and would like to transfer it to a different apparatus. It is useful to enable users of such apparatus to easily transfer the content between the respective apparatus.

### BRIEF SUMMARY

According to various, but not necessarily all, embodiments of the invention there is provided a method comprising: displaying an assessment area on a display of a first apparatus; displaying an item indicative of transfer data in the assessment area where the transfer data originates from a second apparatus; and determining whether a user input has been made accepting the transfer data, wherein if a user input accepting the transfer data has been made, enabling use of the transfer data by the first apparatus and if a user input accepting the transfer data has not been made, preventing use of the transfer data by the first apparatus.

In some embodiments of the invention the user input accepting the transfer data may comprise actuation of the assessment area of the display and actuating an area of the display other than the assessment area.

In some embodiments of the invention the user input accepting the transfer data may comprise a trace input.

In some embodiments of the invention the transfer data may be transferred from the second apparatus to the first apparatus before a user input accepting the transfer data is determined to have been made. In such embodiments preventing use of the transfer data may comprise deleting the transfer data from the first apparatus and enabling use of the transfer data may comprise enabling applications of the first apparatus to access the transfer data.

In some embodiments of the invention the transfer data may be transferred from the second apparatus to the first apparatus in response to the determining that a user input accepting the transfer data has been made. In such embodiments of the invention enabling use of the transfer data may comprise enabling the transfer data to be received by the first apparatus and use of the transfer data may comprise preventing the transfer data being received by the first apparatus.

In some embodiments of the invention the preventing use of the transfer data may occur automatically.

In some embodiments of the invention the transfer data may be transferred directly between the first and second apparatus.

In some embodiments of the invention the user of the first apparatus may also be the user of the second apparatus.

In some embodiments of the invention the method may further comprise in response to the user input accepting transfer data, determining that the user is authorised to accept the data.

In some embodiments of the invention the size of the assessment area may provide an indication of a property of the transfer data.

In some embodiments of the invention the method may further comprise displaying user selectable items in the assessment area wherein, in response to the user selectable item a function associated with the item is enabled to be performed on to transfer data.

In some embodiments of the invention the function associated with the user selectable item may depend upon the type of transfer data.

According to various, but not necessarily all, embodiments of the invention there is provided an apparatus comprising: at least one processor; and at least one memory including computer program code; wherein the at least one memory and the computer program code are configured to, with the at least one processor, enable the apparatus to: display an assessment area on a display of a first apparatus; display an item indicative of transfer data in the assessment area where the transfer data originates from a second apparatus; and determine whether a user input has been made accepting the transfer data, and if a user input accepting the transfer data has been made, enable use of the transfer data by the first apparatus and if a user input accepting the transfer data has not been made, prevent use of the transfer data by the first apparatus.

In some embodiments of the invention the user input accepting the transfer data may comprise actuation of the assessment area of the display and actuation of an area of the display other than the assessment area.

In some embodiments of the invention the user input accepting the transfer data may comprise a trace input.

In some embodiments of the invention the transfer data may be transferred from the second apparatus to the first apparatus before a user input accepting the transfer data is determined to have been made. In such embodiments of the invention preventing use of the transfer data may comprise deleting the transfer data from the first apparatus and enabling use of the transfer data may comprise enabling applications of the first apparatus to access the transfer data.

In some embodiments of the invention the transfer data may be transferred from the second apparatus to the first apparatus in response to the determining that a user input accepting the transfer data has been made. In such embodiments of the invention enabling use of the transfer data may comprise enabling the transfer data to be received by the first apparatus and preventing use of the transfer data may comprise preventing the transfer data being received by the first apparatus.

In some embodiments of the invention the preventing use of the transfer data may occur automatically.

In some embodiments of the invention the transfer data may be transferred directly between the first and second apparatus.

In some embodiments of the invention the user of the first apparatus may also be the user of the second apparatus.

In some embodiments of the invention the apparatus may also be configured to enable, in response to a user input accepting transfer data, determining that the user is authorised to accept the data.

In some embodiments of the invention the size of the assessment area may provide an indication of a property of the transfer data.

In some embodiments of the invention the at least one memory and the computer program code may be configured to, with at least one processor, display user selectable items in the assessment area wherein, in response to the user selectable item a function associated with the item is enabled to be performed on to transfer data.

In some embodiments of the invention the function associated with the user selectable item may depend upon the type of transfer data.

According to various, but not necessarily all, embodiments of the invention there is provided a computer program comprising computer program instructions that, when executed by at least one processor, enable an apparatus at least to perform: displaying an assessment area on a display of a first apparatus; displaying an item indicative of transfer data in the assessment area where the transfer data originates from a second apparatus; and determining whether a user input has been made accepting the transfer data, wherein if a user input accepting the transfer data has been made, enabling use of the transfer data by the first apparatus and if a user input accepting the transfer data has not been made, preventing use of the transfer data by the first apparatus.

According to various, but not necessarily all, embodiments of the invention there is provided a computer program comprising program instructions for causing a computer to perform the method as described above.

According to various, but not necessarily all, embodiments of the invention there is provided a physical entity embodying the computer program as described above.

According to various, but not necessarily all, embodiments of the invention there is provided an electromagnetic carrier signal carrying the computer program as described above.

According to various, but not necessarily all, embodiments of the invention there is provided a user interface comprising: a display, associated with a first apparatus, configured to display an assessment area and an item indicative of transfer data in the assessment area where the transfer data originates from a second apparatus; and a user input device configured to enable a user to make an input accepting the transfer data; wherein if a user input accepting the transfer data is made, use of the transfer data by the first apparatus is enabled and if a user input accepting the transfer data has not been made, use of the transfer data by the first apparatus is prevented.

In some embodiments of the invention the user input accepting the transfer data may comprise actuation of the assessment area of the display and actuation of an area of the display other than the assessment area.

According to various, but not necessarily all, embodiments of the invention there is provided an apparatus comprising: means for displaying an assessment area on a display of a first apparatus; means for displaying an item indicative of transfer data in the assessment area where the transfer data originates from a second apparatus; means for determining whether a user input has been made accepting the transfer data; means for enabling use of the transfer data by the first apparatus if a user input accepting the transfer data has been made; and means for preventing use of the transfer data by the first apparatus if a user input accepting the transfer data has not been made. The apparatus may be for wireless communication.

### BRIEF DESCRIPTION

For a better understanding of various examples of embodiments of the present invention reference will now be made by way of example only to the accompanying drawings in which:

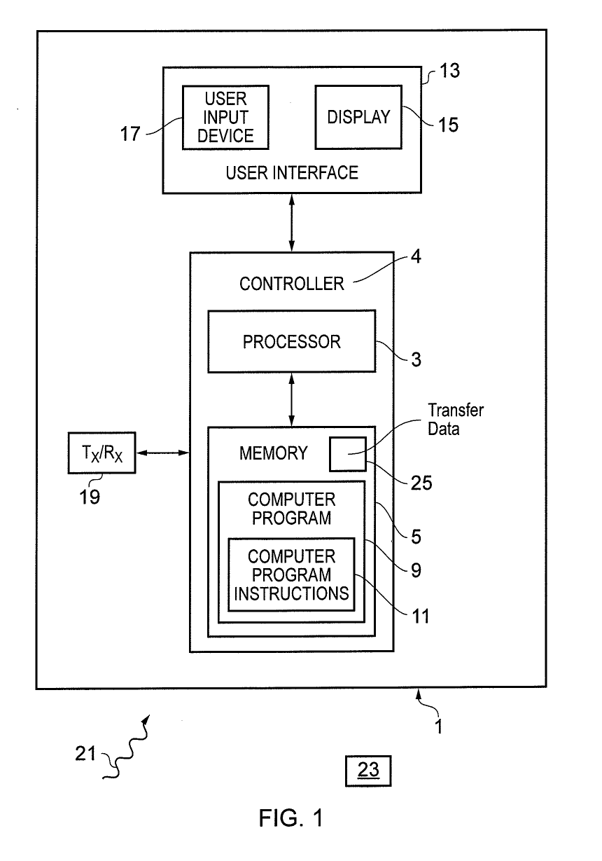

FIG. 1 schematically illustrates an apparatus according to an exemplary embodiment of the invention;

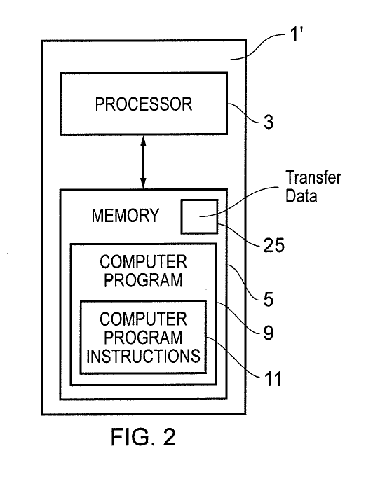

FIG. 2 schematically illustrates an apparatus according to another exemplary embodiment of the invention;

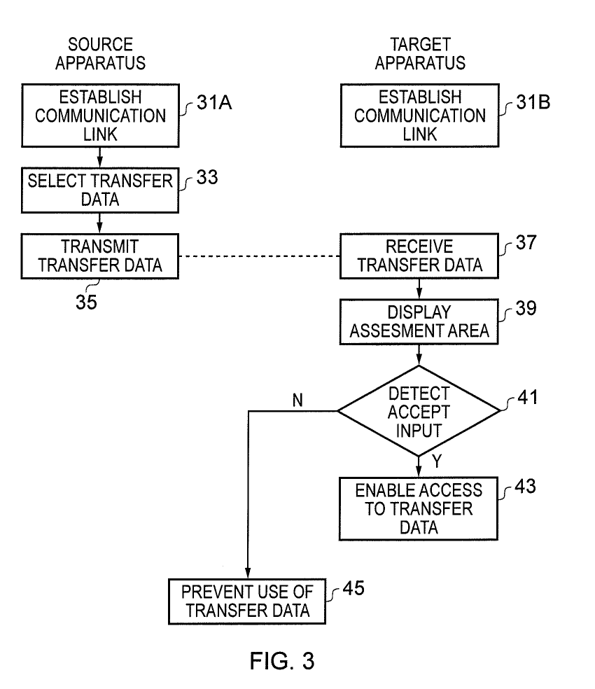

FIG. 3 is a block diagram which schematically illustrates a method according to an exemplary embodiment of the invention;

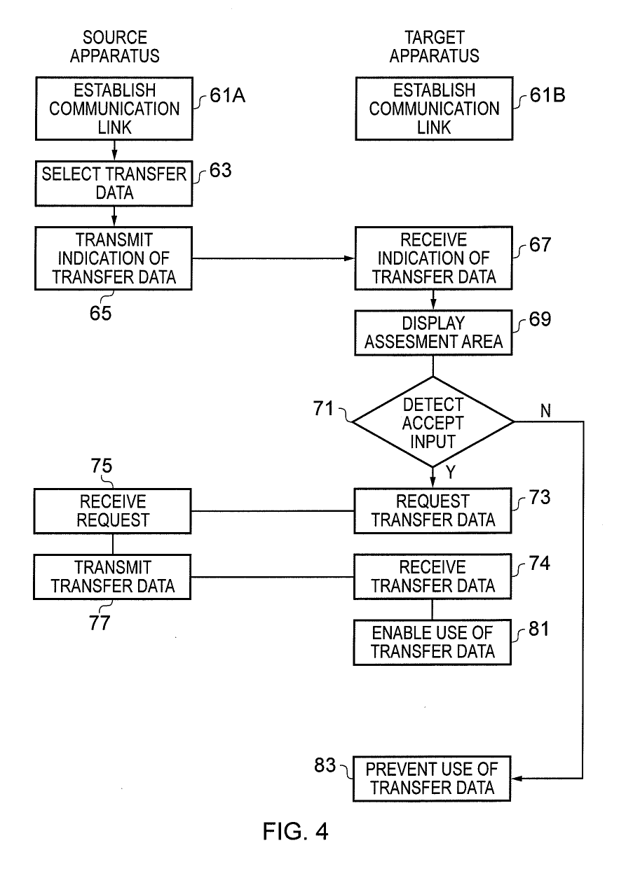

FIG. 4 is a block diagram which schematically illustrates a method according to another exemplary embodiment of the invention;

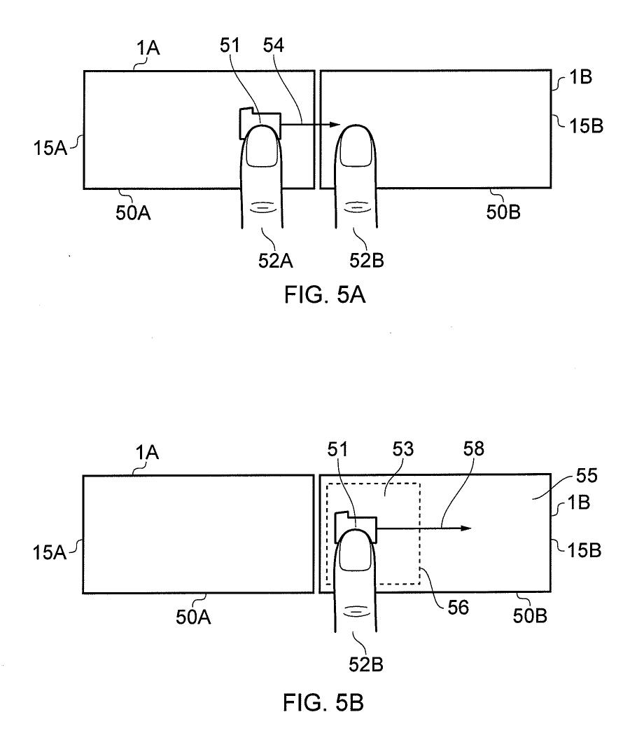

FIGS. 5A and 5B illustrate graphical user interfaces according to an exemplary embodiment of the invention; and

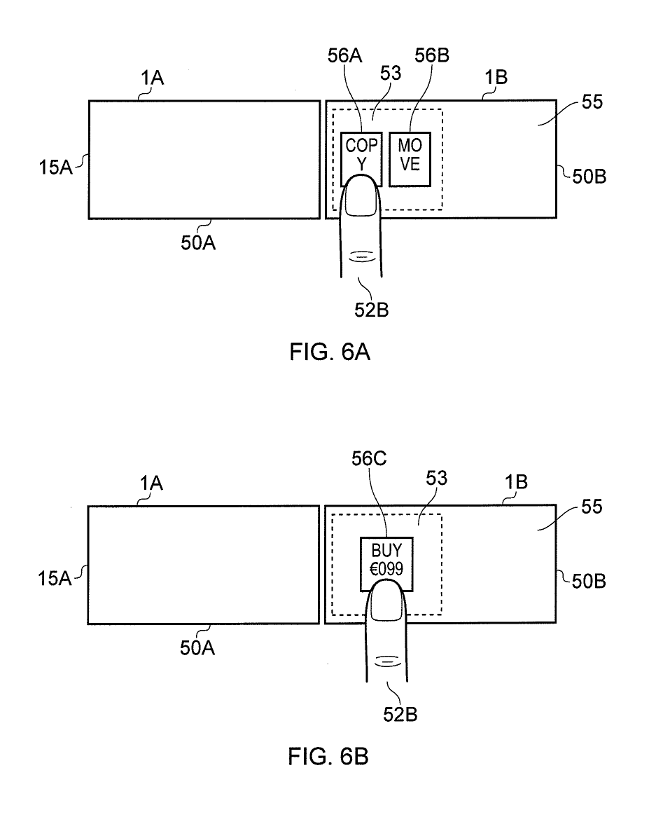

FIGS. 6A and 6B illustrate graphical user interfaces according to another exemplary embodiment of the invention.

### DETAILED DESCRIPTION

The Figures illustrate a method comprising: displaying 39, 69 an assessment area 53 on a display 15B of a first apparatus 1B; displaying an item 51 indicative of transfer data 25 in the assessment area 53 where the transfer data 25 originates from a second apparatus 1A; and determining 41, 71 whether a user input has been made accepting the transfer data 25, wherein if a user input accepting the transfer data 25 has been made, enabling 43, 81 use of the transfer data 25 by the first apparatus 1B and if a user input accepting the transfer data 25 has not been made, preventing 45, 83 use of the transfer data 25 by the first apparatus 1B.

FIG. 1 schematically illustrates an apparatus 1 according to an embodiment of the invention. The apparatus 1 may be an electronic apparatus. The apparatus 1 may be, for example, a mobile cellular telephone, a personal computer, a camera, a gaming device, a personal digital assistant, a personal music player or any other 1 apparatus which may be configured to receive transfer data 25 from another apparatus. The apparatus 1 may also be configured to enable transfer data 25 to be transmitted to another apparatus 1. The apparatus 1 may be a handheld apparatus 1 which can be carried in a user's hand, handbag or jacket pocket for example.

Only features referred to in the following description are illustrated in FIG. 1. However, it should be understood that the apparatus 1 may comprise additional features that are not illustrated. The apparatus 1 illustrated in FIG. 1 may be a source apparatus 1A which provides transfer data 25 to another apparatus or a target apparatus 1B which receives transfer data 25 from another apparatus.

The apparatus 1 illustrated in FIG. 1 comprises: a user interface 13, a transceiver 19 and a controller 4. In the illustrated embodiment the controller 4 comprises at least one processor 3 and at least one memory 5 and the user interface 13 comprises a display 15 and a user input device 17.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of different functions. For example, where the apparatus 1 is a mobile cellular telephone the controller 4 may be configured to control the apparatus 1 to make and receive telephone calls and also to perform other functions such as send messages or access communication networks such as local area networks or the Internet.

The controller 4 may also be configured to enable the apparatus 1B to display 39, 69 an assessment area 53 on a display 15 of a first apparatus 1B; display an item 51 indicative of transfer data 25 in the assessment area 53 where the transfer data 25 originates from a second apparatus 1A; and determine 41, 71 whether a user input has been made accepting the transfer data 25, and if a user input accepting the transfer data 25 has been made, enable 43, 81 use of the transfer data 25 by the first apparatus 1B and if a user input accepting the transfer data 25 has not been made, prevent 45, 83 use of the transfer data 25 by the first apparatus 1B.

The at least one processor 3 is configured to receive input commands from the user interface 13 and also to provide output commands to the user interface 13. The at least one processor 3 is also configured to write to and read from the at least one memory 5. Outputs of the user interface 13 are provided as inputs to the controller 4.

The user input device 17 provides means for enabling a user of the apparatus 1 to input information which may be used to control the apparatus 1. The user input device 17 may also enable a user to input information which may be stored in the one or more memories 5 of the apparatus 1 or transferred to another apparatus.

The user input device 17 may comprise any means which enables a user to input information into the apparatus 1. For example the user input device 17 may comprise a keypad or a portion of a touch sensitive display or a combination of a number of different types of user input devices.

In some embodiments of the invention the user input device 17 may comprise a touch sensitive user input device. The touch sensitive user input device may be arranged relative to the display 15 to enable a user to make inputs via the display 15. The touch sensitive user input device 17 may be actuated by a user contacting the surface of the touch sensitive user input device 17 with an object such as their finger or a stylus. A user may contact the surface of the touch sensitive input device 17 by physically touching the surface of the touch sensitive input device 17 with the object or by bringing the object close enough to the surface to activate the sensors of the touch sensitive input device 17.

The display 15 may be configured to present graphical user interfaces 50 to a user of the apparatus 1. Examples of graphical user interfaces 50A, 50B, according to embodiments of the invention are illustrated in FIGS. 5A, 5B, 6A and 6B.

The display 15 may comprise any means which enables information to be displayed to a user of the apparatus 1. The information may correspond to information which has been received by apparatus 1 via the transceiver 19, information which has been input by the user via the user input device 17 or information which is stored in the one or more memories 5.

The apparatus 1 illustrated in FIG. 1 also comprises a transceiver 19. The transceiver 19 may comprise any means which enables the apparatus 1 to receive transfer data 25 from another apparatus. The transceiver 19 may enable the apparatus 1 to establish a communication link with another apparatus so that transfer data 25 may be exchanged between the first apparatus and the another apparatus. The communication link may enable the transfer data 25 to be exchanged directly between the two apparatus without any intermediary device.

In some embodiments of the invention the transceiver 19 may be configured to enable wireless communication. For example the transceiver 19 may enable short range wireless communication. In such embodiments the transceiver 19 may be configured to operate in a frequency band according to a radio communication protocol such as Bluetooth (2400-2483.5 MHz), WLAN (2400-2483.5 MHz) or NFC (13.56 MHz). The communication range may be several meters or, in some embodiments of the invention the communication range may be several centimeters.

In some embodiments of the invention the transceiver 19 may also be configured to enable long range wireless communication. For example the transceiver 19 may be configured to operate in a cellular communications network.

In some embodiments of the invention the transceiver 19 may be configured to enable wired communication between the apparatus. For example, the transceiver 19 may enable a physical connection to be made between the apparatus 1 and another apparatus so that the transfer data 25 may be transmitted via the physical connection. The physical connection may be, for instance, a USB cable.

The controller 4 may be configured to provide information to the transceiver 19 for transmission over a communication link to another apparatus. The controller 4 may also be configured to decode signals received from the another apparatus by the transceiver 19 into information. The received information may be stored in the one or more memories 5.

It the illustrated embodiment the transceiver 19 has been illustrated as a single entity. It is to be appreciated by a person skilled in the art that, in some embodiments of the invention, the transceiver 19 may comprise a separate transmitter and receiver.

The at least one memory 5 stores a computer program code 9 comprising computer program instructions 11 that control the operation of the apparatus 1 when loaded into the at least one processor 3. The computer program instructions 11 provide the logic and routines that enable the apparatus 1 to perform the methods illustrated in FIGS. 3 and 4. The at least one processor 3 by reading the at least one memory 5 is able to load and execute the computer program 9.

The at least one memory 5 may also store transfer data 25. Where the apparatus 1 is configured to act as a source apparatus 1A the transfer data 25 may be retrieved from the at least one memory 5 and transmitted to a target apparatus 1B via the transceiver 19. The transfer data 25 may be transmitted in response to a user input made using the user input device 17.

Where the apparatus 1 is configured to act as a target apparatus 1B the transfer data 25 may have been received from another apparatus via the transceiver 19. If the transfer data 25 is accepted it may be stored in the one or more memories 5 as illustrated schematically in FIG. 1. Once the transfer data 25 has been stored it may be used by the target apparatus 1B. The transfer data 25 may be accessed by applications of the target apparatus 1B and used to perform functions.

The computer program instructions 11 may provide computer readable program means configured to control the apparatus 1. The program instructions 11 may provide, when loaded into the controller 4; means for displaying 39, 69 an assessment area 53 on a display 15 of a first apparatus 1B; means for displaying an item 51 indicative of transfer data 25 in the assessment area 53 where the transfer data 25 originates from a second apparatus 1A; means for determining 41, 71 whether a user input has been made accepting the transfer data 25; means for enabling 43, 81 use of the transfer data 25 by the first apparatus 1B if a user input accepting the transfer data 25 has been made; and means for preventing 45, 83 use of the transfer data 25 by the first apparatus 1A if a user input accepting the transfer data 25 has not been made.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application integration specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

FIG. 2 illustrates an apparatus 1′ according to another embodiment of the invention. The apparatus 1′ illustrated in FIG. 2 may be a chip or a chip-set. The apparatus 1′ comprises at least one processor 3 and at least one memory 5 as described above in relation to FIG. 1.

Methods of controlling an apparatus 1 to enable the transfer of data from a source apparatus to a target apparatus according to exemplary embodiments of the invention, are illustrated schematically in FIGS. 3 and 4.

In the exemplary embodiment illustrated in FIG. 3 blocks 31A, 33 and 25 may be carried out by a source apparatus 1A and blocks 31B, 37, 39, 41, 43 and 45 may be carried out by a target apparatus 1B. The source apparatus 1A and the target apparatus 1B may be apparatus as illustrated in FIGS. 1 and 2 and so corresponding reference numerals are used in the following description. The suffix A is used for reference to a source apparatus 1A and the suffix B is used for reference to a target apparatus 1B.

At block 31 a communication link is established between the source apparatus 1A and the target apparatus 1B.

The communication link may comprise a wireless communication link, for example it may be a low power radio frequency link such as a Bluetooth connection. In other embodiments of the invention the communication link may comprise a physical connection, such as a USB connection, between the source apparatus 1A and the target apparatus 1B. In the embodiment illustrated in FIG. 3 the establishment of the communication link involves a procedure being carried out by both the source apparatus 1A and the target apparatus 1B. For example, a security protocol may be carried out or for some identification data may be transferred between the two apparatus 1A, 1B. In other embodiments of the invention the establishment 31, 61 of the communication link may be carried out by just one of the apparatus 1A, 1B

In some embodiments of the invention the source apparatus 1A and the target apparatus 1B may be placed adjacent to each other in order to establish 31 the communication link. For example the two apparatus 1A, 1B may be positioned within a few centimeters of each other, or where a physical connection is used they may be brought into contact with each other. In such embodiments of the invention, the apparatus 1A, 1B may comprise means for detecting the proximity of the other apparatus. Such means may comprise, for example, a proximity sensor or may comprise Bluetooth or a wireless LAN communication means.

At block 33 transfer data 25 is selected. The transfer data 25 may be stored in the one or more memories 5A of the source apparatus 1A. The user may select the transfer data 25 by using the user input device 17A to select content or information. The content or information may be presented as one or more user selectable items displayed on the display 15A. The content or information may be presented in a menu of user selectable items which a user may navigate to find the content or information they wish to transfer. In some embodiments of the invention the user may be able to transfer content or information which is currently in use by the source apparatus, for example, a media player could be playing an audio or video file or an image could be displayed on the display 15A of the source apparatus. The information or content may comprise, for example, contact details which enable the apparatus 1A to communicate with other apparatus 1A, images such as photographs or media such as audio or video files.

In response to the user input selecting 33 the content the controller 4A accesses the at least one memory 5A to retrieve the transfer data 25 corresponding to the selected content. An item 51 indicative of the selected transfer data 25 may be displayed on the display 15A. The item 51 may comprise a graphical item and/or text indicative of the transfer data 25.

At block 35 the transfer data 25 is transmitted from the source apparatus 1A to the target apparatus 1B. The transfer data 25 may be transmitted in response to a user input made via the user input device 17A. In an exemplary embodiment the source apparatus 1A comprises a touch sensitive display 15A and the target apparatus 1B is positioned adjacent to the source apparatus 1A to establish the communication link. In such an embodiment the user input which enables the transmission of the transfer data 25 may comprise a trace user input on the touch sensitive display 15B where the trace extends in a direction towards the target apparatus 1B.

In response to the detection of the user input the controller 4 of the source apparatus 1A sends the selected transfer data 25 to the transceiver 19 and enables the selected transfer data 25 to be transmitted to the target apparatus 1B.

At block 37 the target apparatus 1B receives the transfer data 25. Once the transfer data 25 has been received an assessment area 53 is displayed, at block 39, on the display 15B of the target apparatus 1B. The assessment area 53 comprises an area of the display 15B which is visually distinguishable from the other areas of the display 15B. For example, the assessment area 53 may be a demarcated area which has a boundary distinguishing it from the other areas of the display 15B or it may have a different colored background to the other areas displayed on the display 15B.

The item 51 indicative of the transfer data 25 which has been transferred is also displayed on the display 15 of the target apparatus 1B. The item 51 may be displayed within the assessment area 53. This provides an indication to the user of the target apparatus 1B that the transfer data 25 has not been accepted yet and enables the user of the target apparatus 1B to assess whether or not they would like to accept the transfer data 25.

At block 41 the controller 4B of the target apparatus 1B determines whether or not a user input has been made accepting the transfer data 25. The user input to accept the transfer data 25 may comprise a specific type of user input. For example, in embodiments where the user input device 17B of the target apparatus 1B comprises a touch sensitive display 15B, the user input may comprise actuating both the assessment area 53 and an area 55 of the display 15 other than the assessment area 53. In such embodiments the user input may comprise a trace or a sweep user input which begins on the item 51 in the assessment area 53 and extends to an area 55 of the display 15 outside the assessment area 53. Such a user input may be simple and intuitive input for a user to make.

In other embodiments of the invention, the user input may comprise actuating both the assessment area 53 and the area 55 either simultaneously or sequentially, a predetermined time of each other. Where the assessment area 53 and the area 55 are actuated sequentially, the area 55 may have to be actuated within a predetermined time of the actuation of assessment area 53.

If a user input accepting the transfer data 25 has been detected then, at block 43 the use of the transfer data 25 by the target apparatus 1B is enabled. The controller 4B of the target apparatus 1B may enable the use of the transfer data by storing it in the one or more memories 5B and enabling applications of the target apparatus 1B to access the transfer data 25.

If no user input has been made then, at block 45, the use of the transfer data 25 by the first apparatus 1B is prevented. The use of the transfer data 25 may be prevented by preventing applications of the target apparatus 1B from accessing the transfer data 25. If no user input accepting the transfer data 25 is detected within a predetermined period of time then the transfer data 25 may be deleted from the target apparatus 1B. In some embodiments of the invention the user may also be able to make a user input rejecting the transfer data 25 so that in response to the rejection user input the transfer data is deleted from the target apparatus 1B.

The use of the transfer data 25 may be automatically prevented. That is, whenever transfer data 25 is received the default may be to prevent the transfer data from being used until the user of the target apparatus 1B has made an input indicating that they wish to accept the transfer data 25.

FIG. 4 illustrates a method of transmitting and receiving transfer data 25 according to a second exemplary embodiment of the invention. In the exemplary embodiment illustrated in FIG. 4 blocks 61A, 63, 65, 75 and 77 may be carried out by a source apparatus 1A and blocks 61B, 67, 69, 71, 73, 79, 81 and 83 may be carried out by a target apparatus 1B.

Blocks 61 and 63 correspond to blocks 31 and 33 of FIG. 4. At block 61 a communication link is established between the source apparatus 1A and the target apparatus 1B and at block 63 transfer data 25 is selected by the user of the source apparatus 1A.

At block 65, rather than transmit the actual transfer data 25, an indication of the transfer data 25 is transmitted to the target apparatus 1B instead. The indication of the transfer data 25 enables the transfer data 25 to be identified. For example, it may comprise a description or title of content stored in a media file. In some embodiments of the invention it may comprise a small portion of the transfer data 25 which may enable a user to preview the transfer data before it is transferred. The indication of the transfer data 25 may be smaller than the transfer data 25 so it may be transmitted more quickly.

The indication of the transfer data 25 may be transmitted in response to a user input made via the user input device 17A as in the above described embodiments. In response to the detection of the user input the controller 4A of the source apparatus 1A sends the indication of the transfer data 25 to the transceiver 19A and enables the indication of the transfer data 25 to be transmitted to the target apparatus 1B.

At block 67 the target apparatus 1B receives the indication of the transfer data 25. At block 69, once the indication of the transfer data 25 has been received an assessment area 53, as described above in relation to the previous embodiments, is displayed on the display 15B of the target apparatus 1B.

The item 51 indicative of the transfer data 25 is also displayed on the display 15B of the target apparatus 1B. The item 51 may be displayed within the assessment area 51. In this embodiment this provides an indication to the user of the target apparatus 1B that the transfer data 25 has not been received yet.

Block 71 of the exemplary embodiment illustrated in FIG. 4 corresponds to block 41 of the exemplary embodiment illustrated in FIG. 3. At block 71 the controller 4B of the target apparatus 1B determines whether or not a user input has been made accepting the transfer data 25. The user input to accept the transfer data 25 may comprise a specific type of user input such as a trace user input which begins on the item 51 in the assessment area 53 and extends to an area 55 of the display 15 outside the assessment area 53 as described above in relation to the embodiment illustrated in FIG. 3.

If a user input accepting the transfer data 25 has been detected then, at block 73 the target apparatus 1B transmits a request for the transfer data 25 to the source apparatus 1A. At block 73 the source apparatus 1A receives the request for the transfer data 25. In response to the request the controller 4A of the source apparatus 1A retrieves the requested transfer data 25 from the at least one memory 5A and enables it to be transmitted it using the transceiver 19A.

At block 79 the target apparatus 1B receives the requested transfer data 25 and at block 81 the controller 4B enables the transfer data 25 to be used by the target apparatus 1B. The transfer data 25 may be stored in the one or more memory 5B of the target apparatus 1B so that it can be accessed by the applications of the target apparatus 1B. The transfer data 25 may be stored automatically, without any further user input as the user has already indicated their acceptance of the transfer data 25 in block 71.

If no user input indicating acceptance of the transfer data 25 has been detected then the use of the transfer data 25 by the first apparatus 1B is prevented at block 83. In the embodiment illustrated in FIG. 4 the use of the transfer data 25 may be prevented by preventing the transfer data being received by the target apparatus 1B. As the transfer data 25 is not received by the target apparatus 1B it cannot be used or accessed by the application of the target apparatus 1B.

In some embodiments of the invention, the apparatus 1B may prevent or cancel the transfer of the data in response to a cancelling input made by the user. The cancelling input may comprise actuation of only the assessment area 53. For example, it may comprise a trace or a sweep across the assessment area 53 in the general direction towards the source apparatus 1A. The user input may also be determined to be a cancelling input if the user lifts their finger before the trace or sweep extends out of the assessment area 53.

The blocks illustrated in the FIGS. 3 and 4 may represent steps in a method and/or sections of code in the computer program 9. The illustration of a particular order to the blocks does not necessarily imply that there is a required or preferred order for the blocks and the order and arrangement of the block may be varied. For example, in the embodiments illustrated in FIGS. 3 and 4 the communication link is established before the transfer data 25 is selected. However, it is to be appreciated that the transfer data 25 could be selected before the communication link is established. Furthermore, it may be possible for some blocks to be omitted.

FIGS. 5A and 5B illustrate an exemplary embodiment of the invention in use. In FIG. 5A a communication link has been established between a source apparatus 1A and a target apparatus 1B. In this particular embodiment the communication link is a wireless communication link and the two apparatus 1A, 1B are positioned adjacent to each other.

A first graphical user interface 50A is displayed on the display 15A of the source apparatus 1A and a second graphical user interface 50B is displayed on the display 15B of the target apparatus 1B.

The first graphical user interface 50A comprises an item 51 indicative of transfer data 25 which has been selected by user of the first apparatus 1A as described above in relation to FIGS. 3 and 4.

The user of the first apparatus 1A makes a user input indicating that they wish to transfer the selected transfer data 25 from the source device 1A to the target device 1B. In this exemplary embodiment the user input comprises the user actuating the touch sensitive display 15A with their finger 52A in the area in which the item 51 is displayed. The user then makes a trace input in a direction towards the target device 1B as indicated by the arrow 54.

In response to the user input either the transfer data 25 or an indication of the transfer data 25 is transmitted to the target apparatus 1B depending upon whether the embodiment of FIG. 3 or FIG. 4 has been implemented.

In FIG. 5B the target apparatus 1B has received the transfer data 25 or indication of the transfer data 25 and the item 51 indicative of the transfer data 25 is displayed on the display 15B of the target apparatus 1B.

An assessment area 53 is also displayed on the display 15B of the target apparatus 1B. In the illustrated embodiment the assessment area 53 is indicated by the dashed lines 56. It is to be appreciated that the assessment area 53 may be indicated by any suitable means, for example, in other embodiments of the invention, the background area of the assessment area 53 may be a different color to the rest of the graphical user interface 50B.

The item 51 is displayed within the assessment area 53. This provides an indication to the user that the transfer data 25 has not been accepted yet and provides the user of the target apparatus 1B with an opportunity to assess the transfer data 25 before they accept the data. For example, the user of the target apparatus 1B may wish to perform a security check or a virus scan or preview the content before they accept the transfer data 25.

In some embodiments of the invention the assessment area 53 may vary depending upon the context of the transfer data 25 or of the source apparatus 1A. For example, the size of the assessment area 53 may vary depending upon a property of the transfer data 25. In some embodiments of the invention a larger assessment area 53 may be provided for larger files or files which have a higher importance, priority, level of confidentiality or cost associated with them. This enables the user of the target apparatus 1B to easily identify the property such as the importance, priority, confidentiality or cost associated with the transfer data 25. In some embodiments this may also reduce the likelihood of the user inadvertently accepting the transfer data 25 as it may be harder to inadvertently make an accepting input. In alternative embodiments of the invention the color or shape of the assessment area may vary depending on the properties of the transfer data 25.

In some embodiments of the invention the position of the assessment area 53 on the display 15B may depend upon the relative location of the source apparatus 1A. For example, in the illustrated embodiment, the source apparatus 1A is positioned to the left of the target apparatus 1B and so the assessment area 53 is displayed on the left side of the display 15B of the target apparatus 1B. If the source apparatus 1A were positioned to the right of the target apparatus 1B the assessment area 53 may be displayed on the left side of the display 15B. This provides the user of the target apparatus with an indication of the origin of the transfer data 25 as it indicates the relative location of the source apparatus 1A.

In the embodiment illustrated in FIG. 5B the user of the target apparatus 1B wishes to accept the transfer data 25. The user makes an input accepting the transfer data 25 by using their finger 52B to actuate an area of the display 15B in which the assessment area 53 is displayed and also an area 55 of the display 15B in which the assessment area 53 is not displayed. In this particular embodiment the user makes a trace starting on the item 51 and extending out of the assessment area 53 in the direction indicated by the arrow 58.

Once the input accepting the transfer data 25 has been made use of the transfer data 25 by the target apparatus is 1B enabled according to the embodiments described above in relation to FIGS. 3 and 4.

FIGS. 6A and 6B illustrate graphical user interfaces 50A, 50B according to further embodiments of the invention. In these embodiments of the invention further items 56 are displayed in the assessment area 53 in the display 15B of the target apparatus 1B.

In the embodiment illustrated in FIG. 6A the further items comprise user selectable items 56A, 56B associated with functions which may be carried out on the transfer data 25. In this particular embodiment the first user selectable item 56A is associated with the function “copy”. In response to selection of the copy item 56A the transfer data 25 will be copied from the source apparatus 1A so that it is stored in both the source apparatus 1A and the target apparatus 1B.

The second user selectable item 56B is associated with the function “move”. In response to selection of the move item 56B the transfer data 25 will be moved from the source apparatus 1A so that it is stored in the target apparatus 1B and removed from the source apparatus 1A.

It is to be appreciated that user selectable items 56 corresponding to other functions, such as scan for viruses or edit, could also be displayed. The user may select the function to be performed before the transfer data 25 is received or after the transfer data 25 has been received.

In some embodiments of the invention, the functions associated with the user selectable items 56 may be dependent upon the type of data that is transferred. For example, if the transfer data comprises an image, the user selectable items 56 may be associated with functions such as “save to gallery”, “print” or “set as wallpaper” and where the transfer data comprises audio information, the user selectable items 56 may be associated with functions such as “set as ringtone”, “add to playlist” or “save in music folder”.

In the embodiment illustrated in FIG. 6B the user selectable items 56C is associated with the function “buy”. The user selectable item 56C comprises an indication of the function associated with it and also an indication of the cost of the transfer data. In response to the selection of the “buy” user selectable item a transaction occurs in which the target apparatus 1B authorizes a payment and the transfer data 25 is received. The transfer data 25 may be bought from the source apparatus 1A or from a third party.

In some embodiments of the invention it may be beneficial to ensure that only authorized users transfer the data. For example, where data is being bought it may be useful to ensure that the user is authorized to allow the payments to be made. It may also be useful to ensure that the users of the apparatus 1A, 1B are authorized to transmit and receive the transfer data. This may be achieved using any suitable method. In some embodiments of the invention it may be achieved by using biometric information of the users. For example, when a user touches a touch sensitive display 15 to make a user input and transmit or accept transfer data, the apparatus 1A, 1B may be configured to scan the finger of the user and compare it with scans of authorized users.

Embodiments of the invention as described above provide the advantage that they enable the user of the target apparatus 1B to control whether or not the transfer data 25 is accepted. This prevents the user of the target apparatus 1B from receiving content which they do not want.

By displaying the item 51 indicative of the transfer data 25 in the assessment area 53 this enables the user to view the transfer data 25 and also decide whether of not they would like to accept the data. The assessment area 53 enables a user to easily determine which data has or has not been accepted. It may also enable the user to easily determine properties such as relevant importance of the transfer data and/or the relative location of the source apparatus 1A.

The assessment area 53 also enables a user to make a quick and simple input, such as a trace input extending out of the assessment area 53, in order accept the data. Such an input is easy for a user to make and also intuitive so it may make the apparatus 1B easier for the user to use.

In some embodiments of the invention the user may be able to indicate whether or not they would like to accept the transfer data 25 before it is actually been transferred to their apparatus. This may make the transfer of data more convenient for a user as it may avoid unnecessarily transferring large files which may be time consuming.

Although embodiments of the present invention have been described in the preceding paragraphs with reference to various examples, it should be appreciated that modifications to the examples given can be made without departing from the scope of the invention as claimed. For example, in the embodiments described above, the assessment area is displayed once the transfer data or indication of transfer data is received by the target apparatus. In other embodiments of the invention, the assessment area may be displayed in response to an indication from the source apparatus that data is to be transferred, for instance, in response to selection of transfer data by the user of the source apparatus. Alternatively, in embodiments where the two apparatuses are positioned in proximity or connected together, the assessment area could be displayed in response to the detection that the apparatuses are in proximity to each other or that they are connected to each other.

In some embodiments of the invention, the use of the transfer data might not be enabled until a check has been carried out as to whether or not the transfer data is already stored on the target apparatus. This check may be carried out automatically or in response to a user input. If the check determines that the transfer data is not already stored on the target apparatus then the use of the transfer data may then be enabled. If the check determines that the transfer data is already stored on the target apparatus then the use of the transfer data may be prevented, as described above. In such circumstances the data already stored on the target apparatus may be retrieved for the user to use or a notification may be displayed on the display indicating that the data is already stored on the apparatus.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
displaying an assessment area on a display of a first apparatus;
displaying an item indicative of transfer data in the assessment area where the transfer data originates from a second apparatus; and
determining whether a user input has been made accepting the transfer data, wherein if a user input accepting the transfer data has been made, enabling use of the transfer data by the first apparatus and if a user input accepting the transfer data has not been made, preventing use of the transfer data by the first apparatus.

2. A method as claimed in claim 1 wherein the user input accepting the transfer data comprises actuation of the assessment area of the display and actuating an area of the display other than the assessment area.

3. A method as claimed in claim 1 wherein the user input accepting the transfer data comprises a trace input.

4. A method as claimed in claim 1 wherein the transfer data is transferred from the second apparatus to the first apparatus before a user input accepting the transfer data is determined to have been made.

5. A method as claimed in claim 4 wherein preventing use of the transfer data comprises deleting the transfer data from the first apparatus.

6. A method as claimed in claim 4 wherein enabling use of the transfer data comprises enabling applications of the first apparatus to access the transfer data.

7. A method as claimed in claim 1 wherein the transfer data is transferred from the second apparatus to the first apparatus in response to the determining that a user input accepting the transfer data has been made.

8. A method as claimed in claim 7 wherein enabling use of the transfer data comprises enabling the transfer data to be received by the first apparatus.

9. A method as claimed in claim 7 wherein preventing use of the transfer data comprises preventing the transfer data being received by the first apparatus.

10. A method as claimed in claim 1 wherein the preventing use of the transfer data occurs automatically.

11. A method as claimed in claim 1 wherein the transfer data is transferred directly between the first and second apparatus.

12. A method as claimed in claim 1 wherein the user of the first apparatus is also the user of the second apparatus.

13. A method as claimed in claim 1 further comprising, in response to the user input accepting transfer data, determining that the user is authorised to accept the data.

14. A method as claimed in claim 1 wherein the size of the assessment area provides an indication of a property of the transfer data.

15. A method as claimed in claim 1 comprising displaying user selectable items in the assessment area wherein, in response to the user selectable item a function associated with the item is enabled to be performed on to transfer data.

16. A method as claimed in claim 15 wherein the function associated with the user selectable item depends upon the type of transfer data.

17. An apparatus comprising:
at least one processor; and
at least one memory including computer program code;
wherein the at least one memory and the computer program code are configured to, with the at least one processor, enable the apparatus to:
display an assessment area on a display of a first apparatus;
display an item indicative of transfer data in the assessment area where the transfer data originates from a second apparatus; and
determine whether a user input has been made accepting the transfer data, and if a user input accepting the transfer data has been made, enable use of the transfer data by the first apparatus and if a user input accepting the transfer data has not been made, prevent use of the transfer data by the first apparatus.

18. An apparatus as claimed in claim 17 wherein the user input accepting the transfer data comprises actuation of the assessment area of the display and actuation of an area of the display other than the assessment area.

19-32. (canceled)

33. A physical entity embodying a computer program comprising computer program instructions that, when executed by at least one processor, enable an apparatus at least to perform:
displaying an assessment area on a display of a first apparatus;
displaying an item indicative of transfer data in the assessment area where the transfer data originates from a second apparatus; and
determining whether a user input has been made accepting the transfer data, wherein if a user input accepting the transfer data has been made, enabling use of the transfer data by the first apparatus and if a user input accepting the transfer data has not been made, preventing use of the transfer data by the first apparatus.

34. A physical entity embodying a computer program comprising program instructions for causing a computer to perform the method of claim 1.

35-39. (canceled)
